(19) United States
(12) Patent Application Publication
(10) Pub. No.: US 2023/0324032 A1
(43) Pub. Date: Oct. 12, 2023

(54) HEADLAMP

(71) Applicant: LB Marketing, Inc., Alpharetta, GA (US)

(72) Inventors: Douglas Kaye, Alpharetta, GA (US); Kelly Hires, Alpharetta, GA (US); Lauren Lindley, Atlanta, GA (US); Kaif Dosani, Lawrenceville, GA (US)

(21) Appl. No.: 18/130,018

(22) Filed: Apr. 3, 2023

Related U.S. Application Data
(60) Provisional application No. 63/328,922, filed on Apr. 8, 2022.

(51) Int. Cl. F21V 21/096; F21V 21/084; F21L 4/02

(52) U.S. Cl. CPC F21V 21/0965; F21V 21/084; F21L 4/027; F21Y 2101/00

(57) ABSTRACT

Various embodiments for a headlamp having a detachable light are disclosed. In some embodiments a headlamp includes a head guard with a first light source and a removable item with a second light source. The removable item is configured to removably couple to the head guard. The first light source is automatically illuminated when the second light source is removed from the headlamp base.

### CROSS-REFERENCE TO RELATED APPLICATION

This application claims the benefit of and priority to U.S. Provisional Patent Application No. 63/328,922, entitled “HEADLAMP,” filed Apr. 8, 2022, the contents of which are hereby incorporated herein by reference in its entirety.

### BACKGROUND

Several forms of hand-free lighting exist. For instance, lighting devices are often found mounted on helmets or headbands, which prove useful in law enforcement, mining, construction, automotive, manufacturing, or other industries that frequently require hand-free lighting solutions. Existing lighting devices, however, generally include a lighting element that is fixed and not removable from a helmet, headband, or another device. Some removable lighting devices exist; however, these lighting devices are not suitable for hands-free operation and are often not easily removable or attachable to a helmet, headband, or other device.

For instance, U.S. Patent Application No. 2008/0298048 A1 to Garrity discusses a headlamp having a detachable light emitting diode (LED) flashlight and having a strap and a main body made of a flexible material. The flashlight comprises a body and a cap, where the cap is attached to the body by a strap. However, the flashlight of Garrity is not optimal for hand-held operation, and attachment and removal from the strap and body is problematic and labor-intensive. Other deficiencies in the prior art will become apparent.

### FIELD OF THE INVENTION

The present invention relates to a portable lighting device. More specifically, the present invention relates to a headlamp having a detachable flashlight or other illuminated item.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1A is a perspective view of a headlamp with a head guard and a detachable flashlight positioned therein, in accordance with various embodiments of the present disclosure.

FIG. 1B is a perspective view of the headlamp of FIG. 1, where the detachable flashlight is shown detached from the head guard, in accordance with various embodiments of the present disclosure.

FIG. 2A is a top view of the headlamp of FIG. 1 with the head guard and the detachable flashlight positioned therein, in accordance with various embodiments of the present disclosure.

FIG. 2B is a bottom view of the headlamp of FIG. 1 with the head guard and the detachable flashlight positioned therein, in accordance with various embodiments of the present disclosure.

FIG. 2C is a front view of the headlamp of FIG. 1 with the head guard and the detachable flashlight positioned therein, in accordance with various embodiments of the present disclosure.

FIG. 2D is a back view of the headlamp of FIG. 1 with the head guard and the detachable flashlight positioned therein, in accordance with various embodiments of the present disclosure.

FIG. 2E is a right side view of the headlamp of FIG. 1 with the head guard and the detachable flashlight positioned therein, in accordance with various embodiments of the present disclosure.

FIG. 2F is a left side view of the headlamp of FIG. 1 with the head guard and the detachable flashlight positioned therein, in accordance with various embodiments of the present disclosure.

FIG. 3A is a top view of the head guard of the headlamp of FIG. 1, in accordance with various embodiments of the present disclosure.

FIG. 3B is a bottom view of the head guard of the headlamp of FIG. 1, in accordance with various embodiments of the present disclosure.

FIG. 3C is a front view of the head guard of the headlamp of FIG. 1, in accordance with various embodiments of the present disclosure.

FIG. 3D is a back view of the head guard of the headlamp of FIG. 1, in accordance with various embodiments of the present disclosure.

FIG. 3E is a right side view of the head guard of the headlamp of FIG. 1, in accordance with various embodiments of the present disclosure.

FIG. 3F is a left side view of the head guard of the headlamp of FIG. 1, in accordance with various embodiments of the present disclosure.

FIG. 4 shows a top view of the head guard of the headlamp of FIG. 1, as well as two cross-sectional views of the head guard, in accordance with various embodiments of the present disclosure.

FIG. 5A is a top view of the detachable flashlight of the headlamp of FIG. 1, in accordance with various embodiments of the present disclosure.

FIG. 5B is a bottom view of the detachable flashlight of the headlamp of FIG. 1, in accordance with various embodiments of the present disclosure.

FIG. 5C is a front view of the detachable flashlight of the headlamp of FIG. 1, in accordance with various embodiments of the present disclosure.

FIG. 5D is a back view of the detachable flashlight of the headlamp of FIG. 1, in accordance with various embodiments of the present disclosure.

FIG. 5E is a right side view of the detachable flashlight of the headlamp of FIG. 1, in accordance with various embodiments of the present disclosure.

FIG. 5F is a left side view of the detachable flashlight of the headlamp of FIG. 1, in accordance with various embodiments of the present disclosure.

FIG. 6 shows a top view of the detachable flashlight of the headlamp of FIG. 1, as well as a cross-sectional top view of the detachable flashlight, in accordance with various embodiments of the present disclosure.

FIG. 7 shows a front view of the detachable flashlight of the headlamp of FIG. 1, as well as a cross-sectional front view of the detachable flashlight, in accordance with various embodiments of the present disclosure.

FIG. 8 is a perspective view of a headlamp with a head guard and a detachable flashlight with alternative connectors, in accordance with various embodiments of the present disclosure.

### DETAILED DESCRIPTION

The present disclosure relates to a headlamp having a detachable flashlight. Existing hand-free illumination devices generally include a fixed lighting element that is not removable from a helmet or headband. While some devices include a removable lighting element, generally, these devices are not optimal for hand-free illumination. For instance, removal and reattachment of lighting elements in existing products can be time and labor intensive. Providing a detachable lighting element that can be easily removed, attached, and secured to a helmet, headband, or another head-mounted device can present significant technical challenges.

Accordingly, in various embodiments of the present disclosure, a headlamp is described as having a detachable flashlight. The headlamp of the present disclosure can be worn along a strap configured to be worn around the head of a user. Generally, example embodiments of the headlamp include a head lamp base having a first light source and a cavity for receiving a second light source therein. The second light source can be removable by a user. In example embodiments, when the second light source is removed from the base, an illumination trigger can detect that the second light source has been removed and trigger the first light source to be automatically turned on. In some embodiments, a user can selectively illuminate the first and second light sources independently or at the same time.

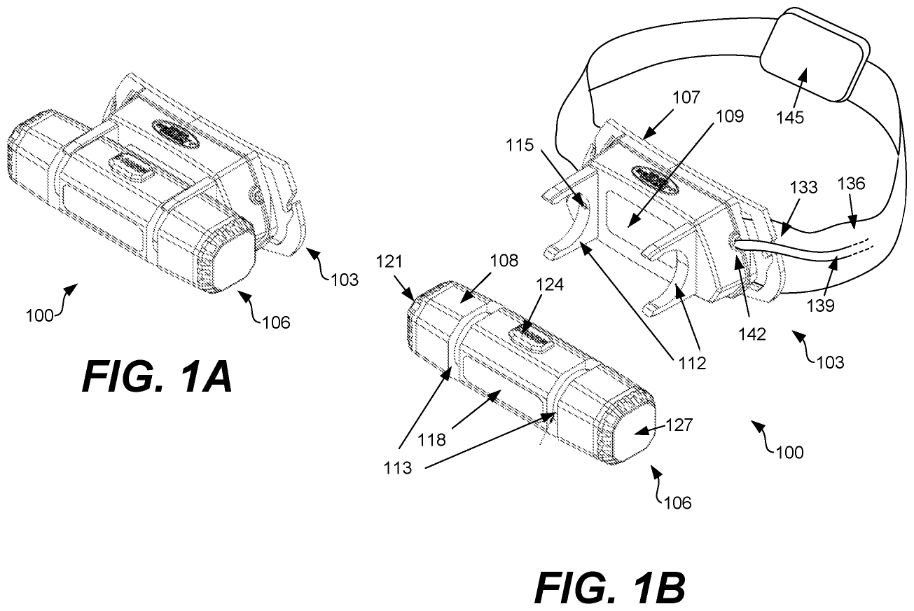

Referring now to the drawings, a portion of a headlamp 100 having a head guard 103 and a detachable flashlight 106 is shown in FIG. 1A according to various embodiments. FIG. 1A shows a perspective view of the headlamp 100 including the head guard 103 and in an instance in which the detachable flashlight 106 is positioned therein. The head guard 103 and the detachable flashlight 106 in some examples can be capable of independent operation including turning their respective light sources on and off using respective switches, buttons, or other control mechanisms. Notably, if the detachable flashlight 106 is removed from one or more cavity or flashlight retention component of the head guard 103, the light source of the head guard 103 can be turned on automatically. A component of the head guard 103 can detect whether the detachable flashlight 106 is attached or detached from the flashlight retention component of the head guard 103, and can trigger the light source of the head guard 103 to be turned on. The detachable flashlight 106 can be referred to as a hybrid headlamp flashlight, or a multi-light source flashlight since it includes both a headlamp type light source and a separate flashlight light source. The head guard 103 can also be referred to as the headlamp base or body.

The special arrangement of the headlamp 100 enables the light source of the detachable flashlight 106 to be aligned with and located directly in front of or anterior to the light source of the head guard 103. This can also place the headlamp-style light source of the detachable flashlight 106 anterior to the light source of the head guard 103. As a result, when the detachable flashlight 106 is detected to be attached, the head guard 103 light source is automatically turned off, since the head guard 103 light source is obscured by the detachable flashlight 106.

In some examples, a button, sensor, or another component of the detachable flashlight 106 can also detect whether the detachable flashlight 106 is attached or detached from the flashlight retention component of the head guard 103, and can trigger one or more light source of the detachable flashlight 106 to be turned on and/or off. For example, when the detachable flashlight 106 is detached, its headlamp-style side-mounted light source can be turned off, and its secondary flashlight-style light source can be turned on.

FIG. 1B shows a perspective view of the headlamp 100, where the detachable flashlight 106 is shown detached from the head guard 103. The head guard 103 is adapted to be worn on a head of an operator. For instance, a flat, curved, or otherwise shaped head and headwear fitting component 107 of the head guard 103 can be ergonomically configured to fit on or near a forehead of an individual, or on a front of a helmet, hat, or other headwear. The headlamp 100 can provide an operator with a hands-free source of lighting for various uses. However, in some situations, it is beneficial to have a hand-held or otherwise separate source of light. For instance, a hand-held flashlight can provide a better source of light in hard-to-reach places, or in various cavities and workspaces. A hanging or magnetically mounted flashlight can provide additional light while freeing both hands for a task. The detachable flashlight 106 can be detached from the head guard 103 such that the detachable flashlight 106 can be operated as a separate source of light similar to a traditional flashlight or a hanging or magnetically mounted work light.

The head guard 103 can include a head guard light source 109, which can include one or more light emitting diodes (LEDs) or another type of light source. The design of the headlamp 100 enables the head guard light source 109 to be aligned with and located directly behind or posterior to the detachable flashlight 106 and primary removable light source 118. This can enable seamless transition from using the detachable flashlight 106 to the head guard light source 109 once the detachable flashlight 106 is removed. In some but not all examples, the head guard light source 109 can have lighting characteristics that match the primary removable light source 118. For example, the total lumens, lumens per unit area, beam angle, and other characteristics can match, or the same make and model of light source can be used. This can further ensure seamless transition from using the head-mounted primary removable light source 118 to the head guard light source 109 once the detachable flashlight 106 is removed.

In some examples, the head guard light source 109 is automatically switched on when the detachable flashlight 106 is removed from one or more cavity or another flashlight retention component 112 of the head guard 103. Here, there are two flashlight retention components 112 that are shown as a set of two C-shaped components that provide an engineering fit around a corresponding set of two connection components 113 of the detachable flashlight 106. The example shown has the flashlight retention components 112 on lateral sides of the head guard light source 109, which is medial to the flashlight retention components 112. In other examples, the one or more flashlight retention components 112 can be located above and/or below the head guard light source 109. The flashlight retention components 112 can enable a rotation or angle adjustment of the detachable flashlight 106 and the primary removable light source 118 when the detachable flashlight 106 is held by the flashlight retention components 112. The angle can be a vertical angle, a horizontal angle, or any angle in various embodiments. When the detachable flashlight 106 and the primary removable light source 118 are adjusted to be straight forward, the detachable flashlight 106 can be both aligned anterior to the head guard light source 109, and the face, lens face, and/or light emitted from the primary removable light source 118 can be parallel, substantially parallel, or face in a same direction relative to that of the head guard light source 109.

The head guard 103 can include a secondary illumination trigger 115. In some examples, the secondary illumination trigger 115 can be located within one or more of the flashlight retention components 112. Further embodiments can locate the secondary illumination trigger 115 anywhere in a footprint of the detachable flashlight 106 on the housing, body, or frontal portion of the head guard 103. The footprint of the detachable flashlight 106 can refer to an area of the head guard 103 that is behind the detachable flashlight 106 when viewed from a front of the headlamp 100 assembly. The secondary illumination trigger 115 can include a switch, button, magnetic sensor, optical sensor, or another sensor that is capable of detecting a presence of the detachable flashlight 106.

Once the detachable flashlight 106 is removed, the secondary illumination trigger 115 can trigger a circuit board or control circuit of the head guard 103 to illuminate the head guard light source 109. In some examples, the head guard 103 can include a power button, switch, or other manual switching control that can turn on and off the head guard light source 109. In other examples, the secondary illumination trigger 115 acts as the primary switching control of the head guard light source 109.

To facilitate the removability and independent operation of the detachable flashlight 106, the detachable flashlight 106 can include a “flashlight” power source independent of the headlamp 100. For instance, in some embodiments, the detachable flashlight 106 can include one or more batteries that permit the detachable flashlight 106 to power one or more removable light source, each of which can include one or more LEDs and other types of light sources, independent of a power supply or other light source of the headlamp 100. The flashlight power source can include rechargeable or non-rechargeable batteries. The light sources of the detachable flashlight 106 can include the “headlamp” 100 or “primary” removable light source 118 and a “secondary” or “flashlight” light source 121.

The detachable flashlight 106 can include a flashlight housing 108. The flashlight housing 108 is shown substantially as an octagonal prism shape that is wider at the center and slightly tapering towards the distal ends approaching the secondary light source 121 and a magnetic component 127. Other shapes can be used for the flashlight housing 108, such as an n-gonal prism shape, tubular shape, and other shapes.

The magnetic component 127 can also be referred to as a magnetic base or magnetic mount. The magnetic mount can enable a user to magnetically affix the detachable flashlight 106 to any ferromagnetic surface. It can also provide a wide enough physical base to stand the detachable flashlight 106 erect on a flat surface with the secondary light source 121 facing upward. The flashlight housing 108 can also include the connection components 113 that connect to the corresponding flashlight retention components 112. As shown, the connection components 113 can be physical indents, grooves, or cavities that mate with the connection components 113. While this example has the connection components 113 of the detachable flashlight 106 fit within the corresponding flashlight retention components 112 of the head guard 103, in other examples the flashlight retention components 112 can fit within the connection components 113.

The flashlight housing 108 can include a button or physical switching control 124 that can control the light sources of the detachable flashlight 106 in conjunction with the processing circuitry (not shown). The processing circuitry of the detachable flashlight 106 can include an integrated circuit (IC) or a microcontroller in some examples. Through operation of the processing circuitry, the power source or switch 145 can toggle the light source and/or mode of operation of the detachable flashlight 106.

The physical switching control 124 can be pressed or manipulated to cycle, toggle, or select various lighting modes of the detachable flashlight 106. In one mode, which can be referred to as a standard or headlamp mode the primary headlamp light source 118 of the detachable flashlight 106 is on while the secondary flashlight light source 121 is off. In another mode, which can be referred to as flashlight mode, the primary headlamp light source 118 is off while the secondary flashlight light source 121 is on. In another mode, all light sources of the detachable flashlight 106 can be off, and in yet another mode, all light sources can be on. In further modes one or both of the primary removable light source 118 and the secondary light source 121 can be set to flash, pulsate, or strobe; can be set to provide a constant light source typical to a flashlight; can be set to a particular color; can be set to continuously or periodically change colors; can be set to various luminous intensities, and other operation as can be appreciated.

The detachable flashlight 106 can, in some embodiments, include its own secondary illumination trigger separate from that of the head guard 103 that detects whether the detachable flashlight 106 is attached or removed relative to the head guard 103. The detachable flashlight 106 can change its mode upon attachment to or detachment from the head guard 103. For example, upon attachment to the head guard 103, the detachable flashlight 106 can change to headlamp mode or another predetermined mode. Upon detachment from the head guard 103, the detachable flashlight 106 can change to flashlight mode or another predetermined mode.

In addition to the detachable flashlight 106 and the head guard 103, the headlamp 100 can also include a headband holder 133, a headband 136 and a power cable 139 that connects the power input 142 to the “head guard” power source 145 and corresponding housing. The headband holder 133 can be a portion of the head and headwear fitting component 107. The headband holder 133 can enable the operator to insert and remove a headband 136 where it can be held securely by tabs of the headband holder 133 once inserted.

In some examples, the housing of the power source 145 (or the head guard 103) can include a power button, switch, or other manual control that can turn on and off the power to the head guard light source 109 in conjunction with processing circuitry for the head guard 103, which can be located in the head guard 103 housing or in the housing of the power source 145.

The processing circuitry for the head guard 103 can include an IC or a microcontroller, which can be separate from the processing circuitry of the detachable flashlight 106. Through operation of the processing circuitry, the switch can toggle the light source and/or mode of operation of the head guard 103. The switch can set the head guard light source 109 to flash, pulsate, or strobe; can set the head guard light source 109 to provide a constant light source typical to a flashlight; can set the head guard light source 109 to a particular color; can set the head guard light source 109 to continuously or periodically change colors; can set the head guard light source 109 to various luminous intensities, and other operation as can be appreciated.

In some examples, the anterior face of the head guard 103 can include electronic connectors through which a charging capability is provided. The charging capability can enable the power source of the detachable flashlight 106 to charge the power source of the head guard 103, the power source of the head guard 103 to charge the power source of the detachable flashlight 106, or both. One or more of the power sources of the head guard 103 and the detachable flashlight 106 can be rechargeable. One or more of the power sources of the head guard 103 and the detachable flashlight 106 can be non-rechargeable.

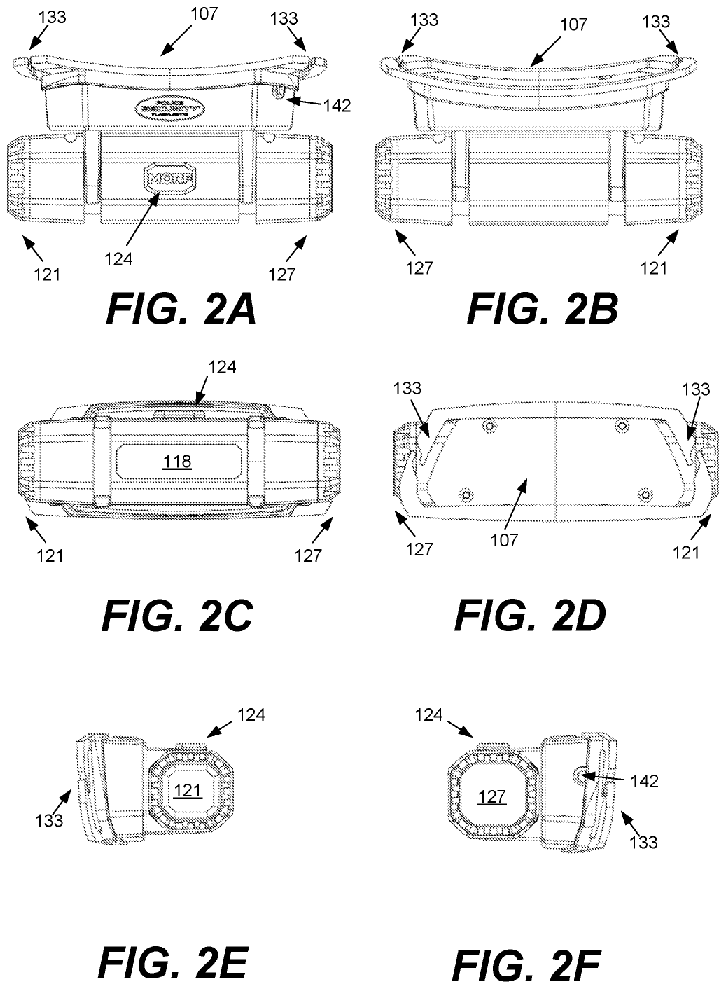

FIG. 2A is a top view of the headlamp 100 with the head guard 103 and the detachable flashlight 106 positioned therein. From this top view, the head and headwear fitting component 107 can be seen to be curved and form-fitting for an operator's head or a headwear item of an operator. The view also shows the headband holders 133 on each side of the head guard 103. This figure also shows a top view of the power input 142, the secondary light source 121, and the magnetic component 127.

FIG. 2B is a bottom view of the headlamp 100 with the head guard 103 and the detachable flashlight 106 positioned therein. From this view, the head and headwear fitting component 107 can be seen to include a recess into which the headband 136 (not shown) fits to provide a flush fit of the head guard 103 and the headband 136 when the headband 136 is held by the headband holders 133. The view also shows the headband holders 133 on each side of the head guard 103. This figure also shows a bottom view of the secondary light source 121 and the magnetic component 127.

FIG. 2C is a front view of the headlamp 100 with the head guard 103 and the detachable flashlight 106 positioned therein. This figure provides a detailed front view of the primary removable light source 118 of the detachable flashlight 106. This figure also shows a front view of the secondary light source 121 and the magnetic component 127.

FIG. 2D is a back view of the headlamp 100 with the head guard 103 and the detachable flashlight 106 positioned therein. This figure provides a clear view of the headband holders 133, which can enable the headband 136 (not shown) to be inserted and held in place securely. The view also shows that in some examples, fasteners such as screws, rivets, pop-on/pop-off components, and other fasteners can affix a headband holder assembly with the head and headwear fitting component 107 to the housing of the head guard 103.

FIG. 2E is a right side view of the headlamp 100 with the head guard 103 and the detachable flashlight 106 positioned therein. This figure provides a more detailed view of the secondary light source 121 and a side view of a headband holder 133.

FIG. 2F is a left side view of the headlamp 100 with the head guard 103 and the detachable flashlight 106 positioned therein. This figure provides a more detailed view of the magnetic component 127 and a side view of a headband holder 133 and the power input 142.

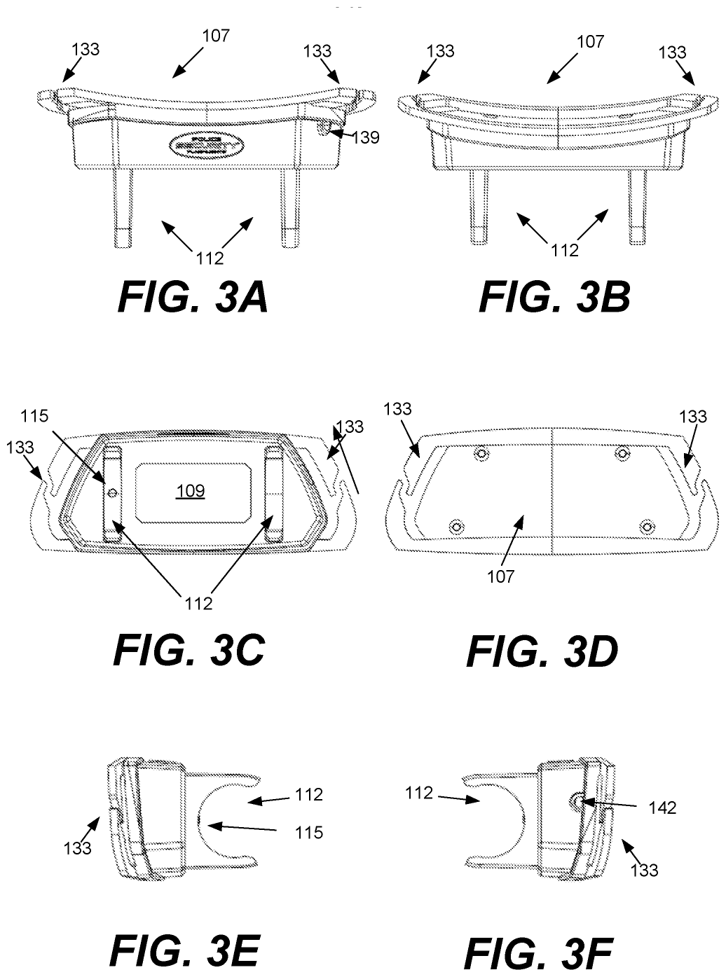

FIG. 3A is a top view of the head guard 103 of the headlamp 100. From this top view, the head and headwear fitting component 107 can be seen to be curved and form-fitting for an operator's head or a headwear item of an operator. The figure also shows the headband holders 133 on each side of the head guard 103. The figure also shows the flashlight retention components 112 protruding from the front of the head guard 103.

FIG. 3B is a bottom view of the head guard 103 of the headlamp 100. From this view, the head and headwear fitting component 107 can be seen to include a recess into which the headband 136 (not shown) fits to provide a flush fit of the head guard 103 and the headband 136 when the headband 136 is held by the headband holders 133. The view also shows the headband holders 133 on each side of the head guard 103. The figure also shows the flashlight retention components 112 protruding from the front of the head guard 103.

FIG. 3C is a front view of the head guard 103 of the headlamp 100. This figure provides a detailed front view of the head guard light source 109 of the head guard 103. This figure also shows a front view of the flashlight retention components 112, the secondary illumination trigger 115, and the headband holders 133.

FIG. 3D is a back view of the head guard 103 of the headlamp 100. This figure provides a clear view of the headband holders 133, which can enable the headband 136 (not shown) to be inserted and held in place securely. The view also shows that in some examples, fasteners such as screws, rivets, pop-on/pop-off components, and other fasteners can affix a headband holder assembly with the head and headwear fitting component 107 to the housing of the head guard 103.

FIG. 3E is a right side view of the head guard 103 of the headlamp 100. This figure provides a more detailed side view of the flashlight retention component 112, the secondary illumination trigger 115, and a side view of a headband holder 133.

FIG. 3F is a left side view of the head guard 103 of the headlamp 100. This figure provides a more detailed side view of the flashlight retention component 112, the power input 142, and a headband holder 133.

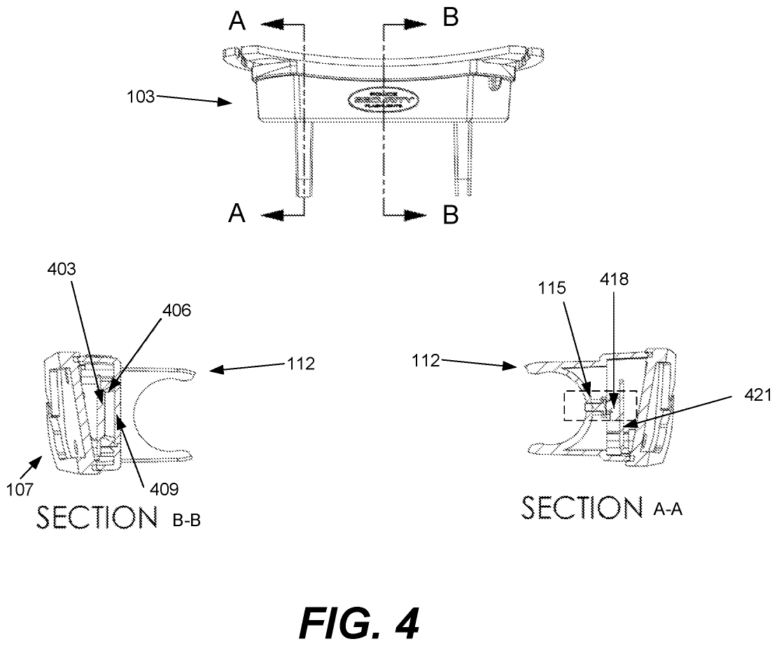

FIG. 4 shows a top view of the head guard 103, as well as two cross-sectional views of the head guard 103. Section A-A is a cross-sectional view that shows the internal portions of a flashlight retention component 112 that includes a secondary illumination trigger 115. Section B-B is a cross-sectional view from the centerline of the head guard 103.

In the centerline section A-A, one example of the flashlight retention component 112 and the secondary illumination trigger 115 can be seen with greater detail. This view shows an example where the flashlight retention component 112 uses a physical retention type such as a cavity that provides an engineering fit around the connection components 113. The secondary illumination trigger 115 can be located at a back portion of the flashlight retention component 112, and in instances where the secondary illumination trigger 115 is a depressible button, it can protrude a distance from the flashlight retention component 112 so that the secondary illumination trigger 115 is depressed when the detachable flashlight 106 is inserted. The secondary illumination trigger 115 can ensure that the head guard light source 109 is turned off when the detachable flashlight 106 is attached to the head guard 103. The secondary illumination trigger 115 in this example can include a physically accessible button as well as the switch or button component 418, connected to a circuit board 421.

In the centerline section B-B, one example of the head guard light source 109 can be seen with greater detail. In this example, the head guard light source 109 can include a lighting circuit board 403. The lighting circuit board 403 can include a chip on board (COB) LED or another type of LED circuit. A light cup 406 can be positioned around and can extend in front of the lighting circuit board 403. In some examples, the light cup 406 can be reflective to increase the amount of light emitted and reduce the light that is absorbed. A lens element 409 can be positioned anterior to the light cup 406. The light cup 406 can hold the lens element 409 a set distance from the lighting circuit board 403, while the housing of the head guard 103 can hold the lens element 409 against the light cup 406.

The lens element 409 can have a ridge at its posterior that is held by a corresponding ridge or bezel of the housing of the head guard 103. The lens element 409 and the housing of the head guard 103 can form a substantially flat surface. This view also shows that the head and headwear fitting component 107 can form a posterior of the housing that is held to an anterior portion of the housing of the head guard 103 using fasteners, which can include pop on fasteners, slide and lock fasteners, screws, rivets, glue, and so on. In some examples, the interior of the housing of the head guard 103 can be weather sealed using one or more gaskets and close fitment between the portions of the housing. In other examples, the housing and/or the head guard 103 generally is not weather sealed but still provides physical and other protection for the circuit boards and lighting therein.

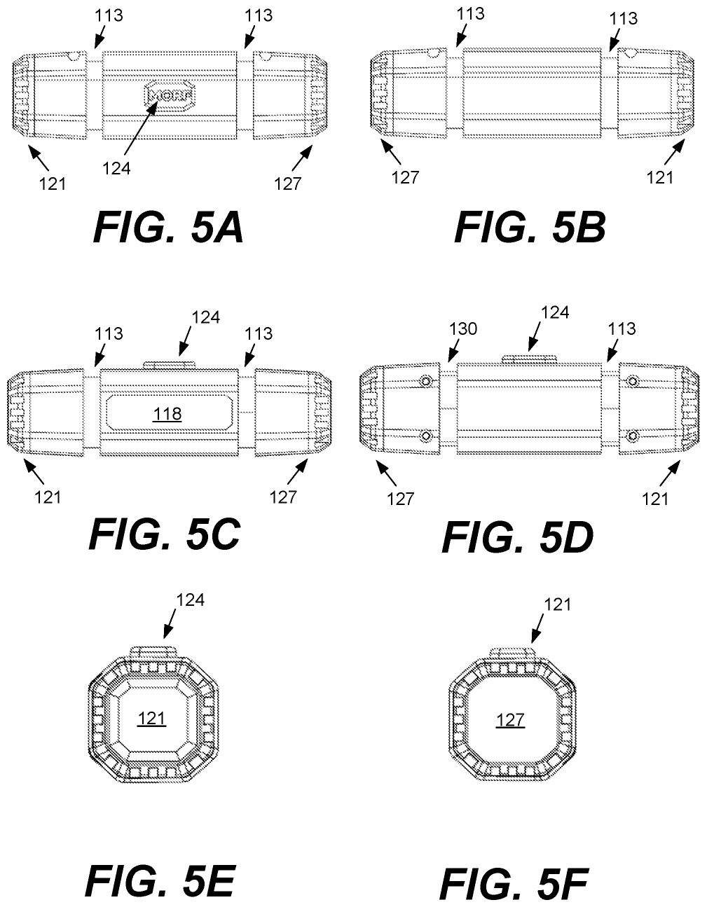

FIG. 5A is a top view of the detachable flashlight 106. This top view shows an example where the connection components 113 are indents in the detachable flashlight 106 that match a width of the flashlight retention component 112, and can provide an engineering fit to both the width of the flashlight retention component 112 and the corresponding cavity of the flashlight retention component 112 that fits around the connection components 113. This figure also shows a top view of the secondary light source 121 and the magnetic component 127.

FIG. 5B is a bottom view of the detachable flashlight 106. This bottom view shows an example where the connection components 113 are indents in the detachable flashlight 106 that match a width of the flashlight retention component 112, and can provide an engineering fit to both the width of the flashlight retention component 112 and the corresponding cavity of the flashlight retention component 112 that fits around the connection components 113. This figure also shows a top view of the secondary light source 121 and the magnetic component 127.

FIG. 5C is a front view of the detachable flashlight 106. This figure provides a detailed front view of the primary removable light source 118 of the detachable flashlight 106. This figure also shows a front view of the secondary light source 121 and the magnetic component 127.

FIG. 5D is a back view of the detachable flashlight 106. This figure provides a detailed back view of the housing of the detachable flashlight 106. This figure also shows a back view of the secondary light source 121 and the magnetic component 127.

FIG. 5E is a right side view of the detachable flashlight 106. This figure provides a more detailed view of the secondary light source 121 and a side view of a headband holder 133.

FIG. 5F is a left side view of the detachable flashlight 106. This figure provides a more detailed view of the magnetic component 127 and a side view of a headband holder 133 and the power input 142.

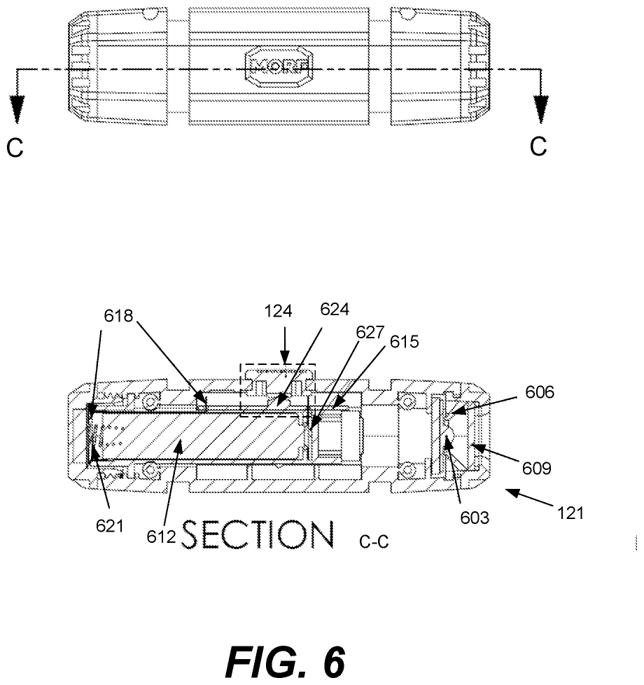

FIG. 6 shows a top view of the detachable flashlight 106, as well as section C-C of the detachable flashlight 106. Section C-C is a top cross-sectional view that shows the internal portions of a detachable flashlight 106. The section C-C shows an LED or other light chip 603, a light cup 606, and a lens 609 of the secondary light source 121 of the detachable flashlight 106. The light chip 603 can be electrically connected to the battery 612 through the circuit board 615. A connection 618 can connect from a negative contact 621 to a negative power input circuit board connection point of the circuit board 615. The physical switching control 124 is shown to include the physical button or switch that extends outside of the housing of the detachable flashlight 106, as well as an internal electronic switch component 624 that is connected to the circuit board 615. A positive contact 627 is also shown, which connects to a positive power input circuit board connection point of the circuit board 615.

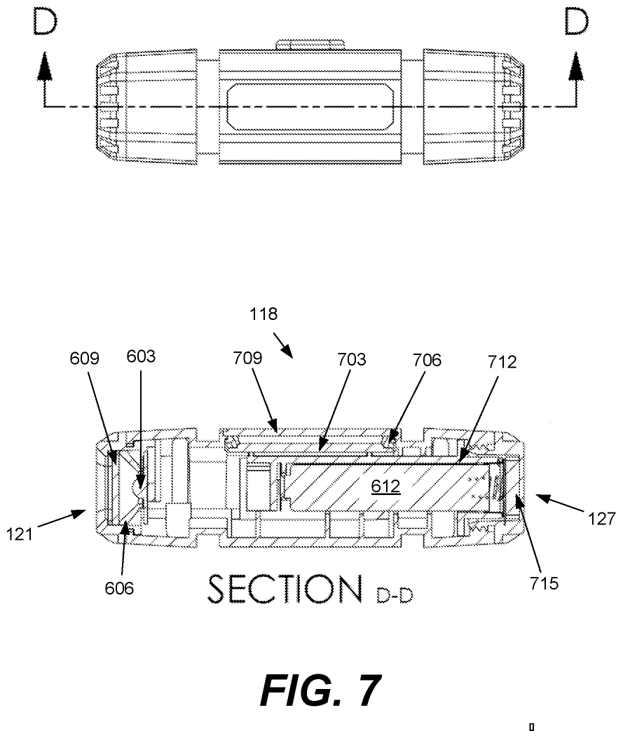

FIG. 7 shows a top view of the detachable flashlight 106, as well as section D-D of the detachable flashlight 106. Section D-D is a front cross-sectional view that shows the internal portions of a detachable flashlight 106. The section D-D shows the LED or other light chip 603, the light cup 606, and the lens 609 of the secondary light source 121 of the detachable flashlight 106. The section D-D also shows that the primary removable light source 118 which includes a COB LED or other lighting circuit board 703, a light cup 706, and a lens element 709. The lighting circuit board 703 can include a COB LED or another type of LED circuit. The light cup 706 can be positioned around and can extend in front of the lighting circuit board 703. In some examples, the light cup 706 can be reflective to increase the amount of light emitted and reduce the light that is absorbed. A lens element 709 can be positioned anterior to the light cup 706. The light cup 706 can hold the lens element 709 a set distance from the lighting circuit board 703, while the housing of the detachable flashlight 106 can hold the lens element 709 against the light cup 706. The lens element 709 can have a ridge at its posterior that is held by a corresponding ridge or bezel of the housing of the detachable flashlight 106. The lens element 409 and the housing of the detachable flashlight 106 can form a substantially flat surface. A battery holder component 712 can provide a cavity for the battery 612. The battery 612 can provide power for both the primary removable light source 118 and the secondary light source 121 of the detachable flashlight 106. The magnetic component 127 can include an internal magnet 715 located inside the housing behind a thin surface that enables the magnetic component 127 to protect the internal magnet 715 while still having the strength to hold the weight of the detachable flashlight 106 when attached to the bottom or a horizontal ferromagnetic surface and in some cases when attached to the side of a vertical ferromagnetic surface.

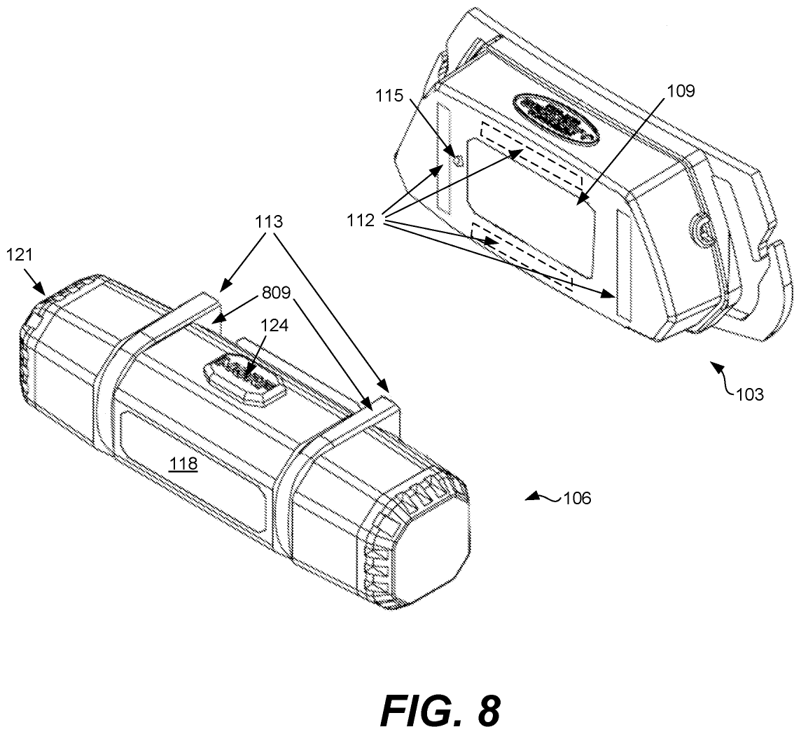

FIG. 8 shows a perspective view of a headlamp 100 with various different types of flashlight retention components 112 and connection components 113, which can generally be referred to as connectors. The various types of connectors can provide a connection between the head guard 103 and the detachable flashlight 106. The connectors can include velcro or other hook and loop connectors, snap-in connectors, button and loop connectors, friction fit connectors, spring loaded clip that mates to a mount (or the housing of the detachable flashlight 106 or head guard 103), magnetic and ferromagnetic connectors, thread-on connectors, twist lock connectors, latch connectors, removable pin lock connectors, slide-in pocket connectors, elastic band connectors, and others.

The connectors can be a mating pair of asymmetric connectors such that different but matching connectors are used on respective ones of the head guard 103 and the detachable flashlight 106. Where connectors are asymmetric, either half of the mating pairs can be used for either one of the head guard 103 and the detachable flashlight 106. For example, the for a hook and loop connection, the hook component can be on either one of the head guard 103 or the detachable flashlight 106, while the loop component can be on the other one of the devices. Likewise, for snap-in connectors, the male snap in connector can be on either one of the head guard 103 or the detachable flashlight 106, while the female component can be on the other one. Other types of asymmetric connectors can also be used in various configurations on the head guard 103 or the detachable flashlight 106 as can be understood. The connectors can include matching magnetic and/or ferromagnetic components, where at least one is magnetized such that each pair forms a magnetic connection. Some magnetic and some mushroom-type hook-and-loop variants can be symmetric in nature, while others are asymmetric as can be understood.

Friction fit connectors can include embodiments that slide in from the front as shown in FIGS. 1-7, but can also slide in from the top, bottom, left, right, or another direction. The friction fit connectors shown in FIGS. 1-7 provide a friction fit and a rotational or angle-adjustment functionality independent from any rotation or angle adjustment of the head guard light source 109. Other friction fit connectors can slide or press into a groove that prevents rotation. For any connector type that prevents or does not provide for rotation of the detachable flashlight in the connector, rotation can be provided using a rotational or angle adjustment component mounted on either one of the head guard 103 or the detachable flashlight 106. Such a rotational or angle adjustment component on the detachable flashlight 106 can provide a rotational or angle-adjustment functionality independent from rotation or angle adjustment of the head guard light source 109. On the other hand, a rotational or angle adjustment component on the head guard 103 can provide a rotational or angle-adjustment functionality of one or both of the head guard light source 109 and the detachable flashlight 106 together or in concert, such that the angle of light of the head guard light source 109 can match that of the detachable flashlight 106 when removed.

Spring loaded clips can include push-on/pull-off spring loaded clips where the “mount” pushes into and pulls out of a spring loaded clip regardless of whether the spring loaded clip can be manually opened using one or more tabs. In other examples, the mount can generally not be designed to be pulled free unless one or more tabs are lifted, depressed, or otherwise manipulated. Thread-on connectors can include examples where the head guard 103 or the detachable flashlight 106 is rotated to engage the threads, as well as examples where a rotating component is rotated while the head guard 103 and the detachable flashlight 106 remain fixed in orientation in relation to one another. Twist lock embodiments enable the detachable flashlight 106 or the head guard 103 to press or rotate a half-turn, quarter-turn, or another fraction of a turn and hold once rotated into place. Latch connectors can include toggle latches, crossbar latches, and others. Pin lock connectors can slide in with or without a friction fit, and further provide a pin that slides into place to hold the head guard 103 and the detachable flashlight 106 once the pin is in place. The pin can include a clevis pin, cotter pin, slotted pin, slotted pin, solid pin, spring pin, safety pin, and other pin designs.

The detachable flashlight 106 of the headlamp 100 is shown detached from the head guard 103. As in FIGS. 1A and 1B, the head guard light source 109 is automatically switched on when the detachable flashlight 106 is removed from the head guard 103. Here, the head guard 103 has flashlight retention components 112 that are shown as a set of one or more components that provide a connection with a corresponding set of one or more connection components 113 of the detachable flashlight 106. The example shown has the flashlight retention components 112 on lateral sides of the head guard light source 109 and the dashed line indicates an alternative positioning of the flashlight retention components 112 above and below the head guard light source 109.

In some embodiments, the front face of the head guard 103 and/or a face of the detachable flashlight 106 can provide one or more alignment components such as a bezel or another protruding portion that fits around or within a complementary portion of the other one of the head guard 103 and/or the detachable flashlight 106. For example, the flashlight retention components 112 can be set within indents, and the connection components 113 can seat within the indents. Alternatively, the head guard 103 can have a bezel about a periphery of the front or anterior face of its housing, and the side of the detachable flashlight 106 that includes connection components 113 can have a shape that is complementary to the bezel.

As in the physical connection embodiments, the head guard 103 can include a secondary illumination trigger 115. In the example shown, the secondary illumination trigger 115 is on the front or anterior face of the head guard 103, and adjacent to one of the flashlight retention components 112. In further examples, the secondary illumination trigger 115 can be located in a cutout in the flashlight retention components 112, similar to the configuration shown in FIG. 4 for the physical connection embodiment. Further embodiments can locate the secondary illumination trigger 115 anywhere in a footprint of the detachable flashlight 106 on the housing, body, or frontal portion of the head guard 103. The footprint of the detachable flashlight 106 can refer to an area of the head guard 103 that is behind the detachable flashlight 106 when viewed from a front of the headlamp 100 assembly. The secondary illumination trigger 115 can include a switch, button, magnetic sensor, optical sensor, or another sensor that is capable of detecting a presence of the detachable flashlight 106. For example, one or more of the flashlight retention components 112 can be used in a circuit that detects a presence of the detachable flashlight 106 based on the connection components 113 being proximal to the flashlight retention components 112.

Once the detachable flashlight 106 is removed, the secondary illumination trigger 115 can trigger a circuit board or control circuit of the head guard 103 to illuminate the head guard light source 109. In some examples, the head guard 103 can include a power button, switch, or other manual switching control that can turn on and off the head guard light source 109. In other examples, the secondary illumination trigger 115 acts as the primary switching control of the head guard light source 109.

As in other embodiments, the physical switching control 124 can be pressed or manipulated to cycle, toggle, or select various lighting modes of the detachable flashlight 106. In one mode, which can be referred to as a standard or headlamp mode the primary headlamp light source 118 of the detachable flashlight 106 is on while the secondary flashlight light source 121 is off. In another mode, which can be referred to as flashlight mode, the primary headlamp light source 118 is off while the secondary flashlight light source 121 is on. In another mode, all light sources of the detachable flashlight 106 can be off, and in yet another mode, all light sources can be on. In further modes one or both of the primary removable light source 118 and the secondary light source 121 can be set to flash, pulsate, or strobe; can be set to provide a constant light source typical to a flashlight; can be set to a particular color; can be set to continuously or periodically change colors; can be set to various luminous intensities, and other operations as can be appreciated.

Although relative terms are used in this specification, such as “up” and “down” to describe the relative relationship between one component and another component of an icon, these terms are used in this specification for convenience only, for example according to the directions of the examples described in the drawings. It can be understood that if the device is turned upside down, the component described “up” will become the component “down.” When a structure is “on” or “positioned on” another structure, it may mean that a structure is integrally formed on another structure, or that a structure is “directly” arranged on another structure, or that a structure is arranged “indirectly” on another structure through another structure.

The terms “a,” “an,” “the,” and “said” are used to indicate that there are one or more elements, components, etc. The terms “comprising” and “having” are used to indicate open-ended inclusion, and refers to that, in addition to the listed elements, components, etc., there may be other elements, components, etc. The terms “first” and “second” are used only as labels, and are not intended to be a limitation on the number of objects. The term “substantially” can describe an approximate fit, value, direction, orientation, or other parameter within a predetermined tolerance such as 1%, 2%, 3%, 4%, 5%, or another predetermined tolerance.

It should be emphasized that the above-described embodiments of the present disclosure are merely possible examples of implementations set forth for a clear understanding of the principles of the disclosure. While a feature can be described in connection with a particular figure, the feature can also be combined with features of the other figures. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A headlamp, comprising:
a headlamp base comprising a first light source; and
a second light source configured to removably couple to the headlamp base proximal to the first light source, wherein when the second light source is removed from the headlamp base, the first light source is automatically illuminated.

2. The headlamp of claim 1, comprising:
at least one retention component attached to the headlamp base, wherein the at least one retention component couples the second light source to the headlamp base in conjunction with a corresponding at least one connection component of the second light source.

3. The headlamp of claim 2, wherein a plurality of connectors comprising the at least one retention component and the at least one connection component comprise at least one of: a hook and loop connector, a snap-in connector, a button and loop connector, a friction fit connector, a spring loaded clip that mates to a mount, a magnetic connector, a threaded connector, a twist lock connector, a latch connector, a pin lock connector, a pocket connector, and an elastic band connector.

4. The headlamp of claim 1, comprising:
a switching component for the second light source, wherein the switching component selects between or toggles between a plurality of lighting modes of the second light source.

5. The headlamp of claim 1, comprising:
a headband holder attached to or forming a portion of the headlamp base.

6. The headlamp of claim 1, comprising:
a magnetic base attached to a removable item comprising the second light source.

7. The headlamp of claim 1, wherein the first light source and the second light source have separate power sources.

8. A system, comprising:
a head guard comprising a first light source; and
a removable item comprising a second light source, the removable item being configured to removably couple to the head guard, wherein when the second light source is removed from the headlamp base, the first light source is automatically illuminated.

9. The system of claim 8, wherein the removable item further comprises a third light source at a distal end of a housing of the removable item.

10. The system of claim 8, wherein the second light source is located at a central point along a side of a housing of the removable item.

11. The system of claim 8, comprising:
a headband holder attached to or forming a portion of the head guard.

12. The system of claim 8, wherein the removable item further comprises a magnetic base at a distal end of a housing of the removable item.

13. The system of claim 8, wherein the first light source and the second light source have separate power sources.

14. The system of claim 8, wherein at least one of the first light source and the second light source comprises a chip on board light emitting diode.

15. A method, comprising:
providing a headlamp, wherein the headlamp comprises:
a head guard adapted to be worn on a head or on headwear, the head guard comprising a first light source; and
a removable item comprising a second light source, the removable item being configured to removably couple to the head guard; and
decoupling the removable item relative to the head guard, wherein when the second light source is decoupled from the headlamp base, the first light source is automatically illuminated.

16. The method of claim 15, wherein the removable item further comprises a third light source at a distal end of a housing of the removable item.

17. The method of claim 15, wherein the second light source is located at a central point along a side of a housing of the removable item.

18. The method of claim 15, wherein the head guard comprises a headband holder.

19. The method of claim 15, wherein the removable item further comprises a magnetic base at a distal end of a housing of the removable item.

20. The method of claim 15, wherein decoupling the removable item relative to the head guard automatically illuminates the first light source.
